(19) United States
(12) Patent Application Publication
(10) Pub. No.: US 2004/0264661 A1
(43) Pub. Date: Dec. 30, 2004

(54) Emergency alert notification system and method

(76) Inventor: Shane Harris, Baltimore, MD (US)

Correspondence Address: LAW OFFICE OF LAWRENCE E LAUBSCHER, JR, 1160 SPA RD, SUITE 2B, ANNAPOLIS, MD, 21403, US

(21) Appl. No.: 10/609,287

(22) Filed: Jun. 27, 2003

(51) Int. Cl. H04M 11/04; H04M 15/00

(52) U.S. Cl. 379/127.01; 379/45

(57) ABSTRACT

An emergency alert notification system and method are provided by which a subscriber's previously-identified contact persons may be notified upon the happening of an event. A witness, who may be a stranger to the event, initiates the notification process by contacting a service provider using a phone number and subscriber ID number that has been displayed by the subscriber in strategic locations such as an auto windshield, on the exterior of a home or office, or on a key ring. The witness need know no private or sensitive personal information about the subscriber in order to initiate the notification, and receives no such information as a result of the notification process. With the subscriber's ID number, the service provider retrieves associated contact information and provides notification.

### BACKGROUND OF THE INVENTION

The present invention relates to the field of subscriber emergency notification systems, and more specifically to a system and method for notifying previously designated contacts when the subscriber may be unable to do so personally.

Many systems are presently available to permit notification to designated persons in the event of an emergency. Fully automated building alarm systems are connected into telephone systems to permit automatic notification to emergency personnel, such as fire, police, or medical personnel, when an alarm is activated. Subscriber systems commonly interpose a service provider in the system between the alarm and the emergency personnel to add a measure of protection against false alarms reaching the emergency personnel. An additional benefit of subscriber systems is that persons in addition to the emergency personnel can also be notified. U.S. Pat. No. 6,295,346 to Markowitz et al. describes one such system, in which both emergency personnel and other designated persons may be notified. In the event of an emergency, the subscriber contacts the service provider and provides an identifier to establish his identity. Using the identifier, the service provider queries a previously created contact database to correlate the identity of the calling party with one or more parties to be notified. The service provider then establishes communication with the persons to be contacted and relays a pre-recorded message.

One disadvantage of the above-described system is that it presumes that the subscriber is the calling party and is personally able to initiate the emergency call. In situations where the subscriber is, due to the circumstances of the emergency, unable to place the call, a stranger on the scene would not know the subscriber's identification number, would not know to place an emergency call through the service provider, or would not necessarily have access to the specific telephone that would initiate an automated number identifier system.

There is a need for an emergency alert notification system that permits a stranger on the scene of an emergency to act on behalf of a subscriber to activate the system.

### SUMMARY OF THE INVENTION

The present invention is an emergency alert system and method that overcomes the disadvantages of the prior art and provides additional substantial improvements. Various embodiments described below employ alternative devices for providing a stranger with the information necessary to activate the system without giving the stranger unnecessary, and potentially harmful, information about the subscriber's identity or the identity of designated subscriber contact. Alternative embodiments permit the stranger to provide specific information about the emergency that can be relayed to the contacts and also ensure that contacts are, in fact, verifiably notified.

A method that provides these and other advantages includes producing an ID number uniquely associated with an individual subscriber and then generating a list of persons to be notified upon the occurrence of an event. The ID number is placed in strategic public locations associated with the subscriber, where a witness to the event sees the ID number and uses it to notify a service provider. Using the unique ID number, the service provider looks up the associated contact information in a database and contacts at least one of the persons to be notified.

### BRIEF DESCRIPTION OF THE DRAWINGS

Other objects and advantages of the invention well become apparent from a study of the following specification when viewed in light of the accompanying drawings, in which:

FIG. 1 is a block diagram of a system illustrating an embodiment of the invention; and

FIG. 2. is a flow diagram depicting the method steps of an embodiment of the invention.

### DESCRIPTION OF THE PREFERRED EMBODIMENT

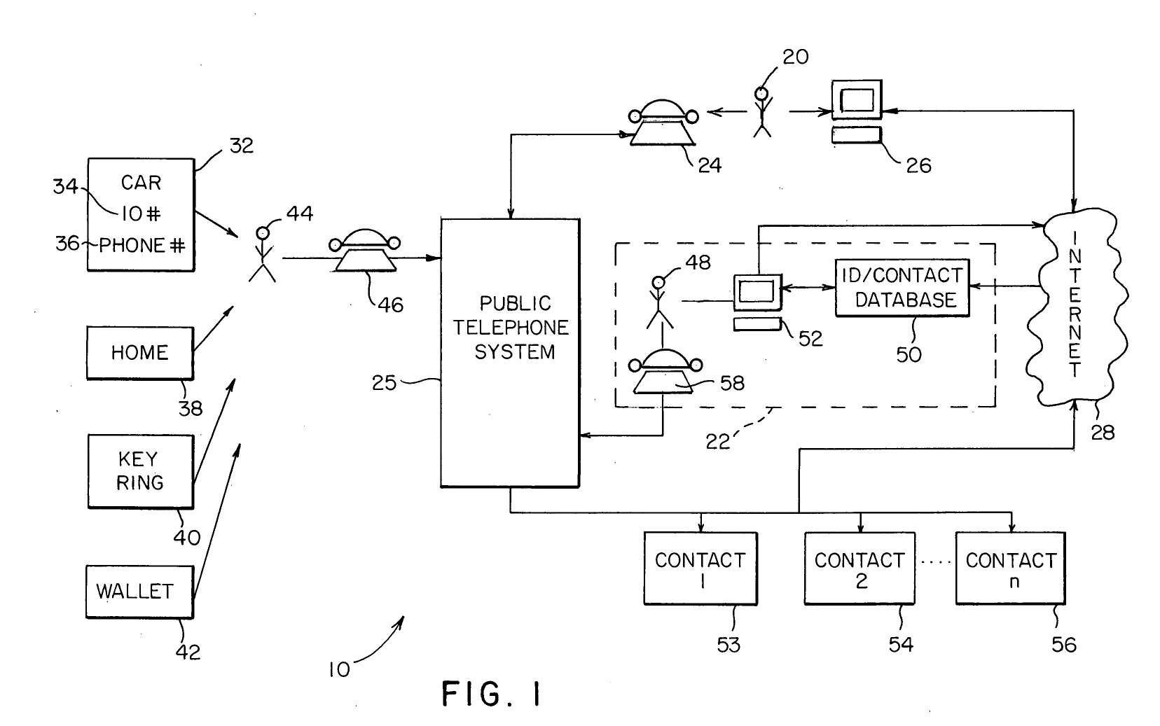

FIG. 1 is an emergency alert notification system 10 illustrating an embodiment of the present invention.

A subscriber 20 communicates with a service provider 22 via a telephone 24 connected to a public telephone system 25 or a computer terminal 26 connected to the Internet 28. Indicia such as a sign, adhesive sticker, tag or card is affixed by subscriber 20 at locations where it might be seen by an observer of an emergency. For example, indicia 32 represents an adhesive sticker affixed to the window of an automobile. Printed on indicia 32 are a telephone number 34 and a subscriber identification (ID) number 36. Indicia 38 represents a sign or adhesive sticker affixed to a subscriber's home, office or similar structure. Indicia 40 represents a tag affixed to a key ring or similar item commonly carried by a subscriber. Indicia 42 represents a card, preferably about the size of a conventional credit card, suitable for being carried in a subscriber's wallet or purse. Each of the indicia types 38, 40 and 42 also has printed on it the telephone number 34 and ID number 36. The above examples should be understood to be representative examples only, and other indicia types are also within the scope of the invention.

An individual 44 at the scene of an emergency places a call on a telephone 46 connected to public telephone system 25 to service provider 22 using telephone number 34. Service provider 22 is preferably staffed 24 hours a day, seven days a week by a representative 48 to answer incoming calls. Representative 48 has access to an information database 50 through a computer terminal 52, which contains previously entered information about persons to be contacted. The representative initiates direct communication with any or all of contacts 53, 54, 56 by alternative methods such as a telephone 59 connected to public telephone system 25 or through e-mail over the Internet 28 via terminal 52.

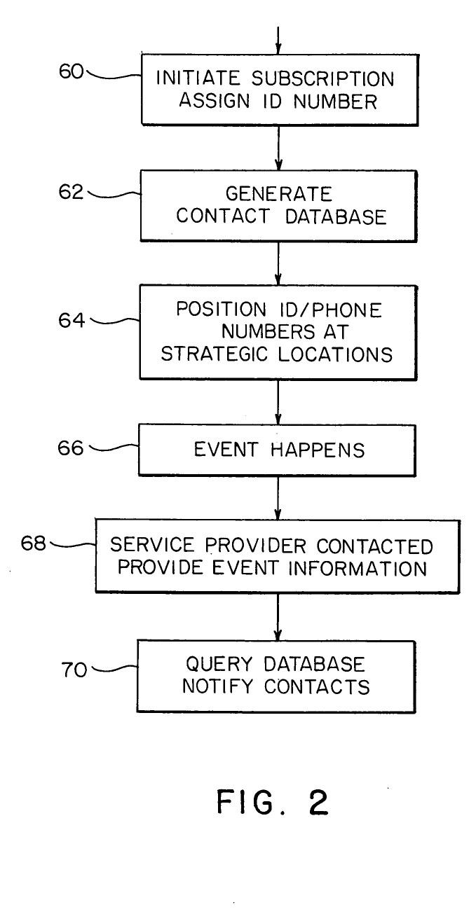

Referring to FIG. 2, service initiation 60 begins when a new subscriber contacts the service provider to initiate a subscription. The service provider assigns a unique ID number to the subscriber. Next, a contact information database is populated 60 from information about contacts provided to the service provider by the subscriber. The subscriber places cards, stickers or tags displaying the ID number and provider telephone number at strategic locations 64. Upon the occurrence of an emergency 66, the service provided is contacted 68 by a witness to the event who discovers the ID and service provider telephone numbers. The service provider uses the ID number to query the database, retrieve contact information, and notify the contacts 70.

In practicing the present invention, service provider 22 advertises the alert notification service for use by subscribers 20. Personnel 48 answer calls via telephone 58 from subscribers 20 for initiating and changing service. Personnel 48 also answer calls from an individual 44 providing information about an emergency via telephone 46. Database 50 is accessible by personnel 48 through computer terminal 52 for storage of subscriber-provided information about the subscriber, the subscriber's ID number, and persons to be contacted in the event of an emergency.

A new subscriber 20 initiates service by contacting service provider 22, receiving an ID number 34, and providing information about persons to be contacted 53, 54, 56. Service provider 22 sets up a master account in database 50 for each subscriber. A subscriber master account may include, for example, some or all of the following items:

| Subscriber | Contact 1 | Contact n |
|---|---|---|
| First Name | First Name | First Name |
| Last Name | Last Name | Last Name |
| Middle Initial | Middle Initial | Middle Initial |
| Street Address | Street Address | Street Address |
| Apt. No. or Suite | Apt. No. or Suite | Apt. No. or Suite |
| City | City | City |
| State | State | State |
| Zip Code | Zip Code | Zip Code |
| Daytime Phone Number | Daytime Phone Number | Daytime Phone |
| | | Number |
| Evening Phone Number | Evening Phone Number | Evening Phone |
| | | Number |
| Cell Phone Number | Cell Phone Number | Cell Phone Number |
| Pager Number | Pager Number | Pager Number |
| E-Mail Address | E-Mail Address | E-Mail Address |
| Account ID Number | Account ID Number | Account ID Number |

In a first embodiment of the invention, subscriber and contact information may be provided by subscriber 20 via telephone 24 directly to the service provider representative 48. Representative 48 keyboards the orally received information into database 50 using terminal 52. In an alternative embodiment of the invention, subscriber 20 contacts service provider 22 via a web address and the Internet 28. Using a computer terminal 26, subscriber 20 provides information as suggested in Table 1 above directly into database 50 to set up the account. In either embodiment, each subscriber is provided with a unique ID number and the telephone number for accessing the alert notification system. Preferably, the ID number and access telephone number are provided on wallet-size cards, adhesive stickers, signs, tags suitable for attaching to a key ring, or other devices that are easily visible and likely to be discoverable by witnesses to an emergency involving the subscriber or the subscriber's property. Representative examples of places such indicia might be used include, but are not limited to, the subscriber's automobile window, office window, home window, wallet or purse, or key ring. It is to be understood that the above examples are examples only and that many other locations are also contemplated as within the scope of the invention.

In the event of an emergency, including one in which the subscriber is incapacitated, absent, or otherwise unable to initiate notification to interested persons, any individual 44 finding one of the indicia may activate the emergency alert notification system 10 by using the access telephone number 36 and providing the subscriber's ID number 34 to service provider representative 48. It is likely that individual 44 will be a witness to the event and will have pertinent information about the event that will be of value to the contacts. Representative 48 receives any information provided by individual 44, preferably including at least the time, place and type of emergency. A particular advantage of the present invention is that anyone, even one who is a stranger to the subscriber, can initiate the emergency alert notification system without jeopardizing any significant private information of the subscriber. For example, no information will necessarily be revealed to the calling individual about either the subscriber's or a contact's identity, address, or phone number. While such information would likely be inadvertently revealed to one finding the indicia in a card carried in the subscriber's wallet or purse, such is incidental to, and not a result of, the notification system itself.

Upon notification of an emergency, a service provider representative 48 immediately enters the subscriber ID number into terminal 52. Contact information associated with the unique subscriber ID is retrieved from database 50 and displayed on the screen of terminal 52. With this contact information, representative 48 initiates contact attempts until one or more of the contacts have been verifiably contacted. In one embodiment of the invention, service provider representative 48 initiates contact using telephone 58 and verification of notification is assured by the direct oral communication of information by the representative to the contact. In an alternative embodiment, information is provided by representative 48 to each contact by means of an email sent from terminal 52 via the Internet 28. Verification can be assured by requiring that a contact reply to the email message when received.

While the preferred forms and embodiments of the invention have been illustrated and described, it will be apparent to those of ordinary skill in the art that various changes and modifications may be made without deviating from the inventive concepts set forth above.

What is claimed is:

1. A method for notifying interested persons of an event, comprising:
a. producing an ID number uniquely associated with an individual subscriber;
b. generating a list of persons to be notified upon the occurrence of an event;
c. providing the ID number at strategic public locations associated with the subscriber;
d. upon the happening of an event, providing the ID number to a service provider; and
e. contacting at least one of the persons to be notified.

2. The method of claim 1 wherein providing the ID at strategic public locations further comprises placing the ID on the subscriber's vehicle

3. The method of claim 1 wherein providing the ID at strategic public locations further comprises placing the ID on the subscriber's home.

4. The method of claim 1 wherein providing the ID at strategic public locations further comprises placing the ID on the subscriber's key ring.

5. The method of claim 1 wherein providing the ID at strategic public locations further comprises placing the ID on a card in the subscriber's wallet.

6. The method of claim 1 wherein the step of providing the ID to a service provider further includes providing the ID to a service provider by a person who is a stranger to the subscriber.

7. The method of claim 6 wherein the step of providing the ID to a service provider further includes providing information about the event to the service provider

8. The method of claim 7 wherein the step of contacting at least one of the persons to be notified further includes the step of providing information about the event to the person to be notified.

9. The method of claim 1 wherein the step of contacting at least one of the persons to be notified further includes the step of contacting the person by telephone.

10. The method of claim 1 wherein the step of contacting at least one of the persons to be notified further includes the step of contacting the person by email.

11. The method of claim 1 wherein the step of generating a list of persons to be notified upon the occurrence of an event further includes the step of providing information about persons to be notified into a web secure database by the subscriber.

12. The method of claim 1 wherein the step of generating a list of persons to be notified upon the occurrence of an event further includes the step of providing information about persons to be notified into a database by a service provider representative.

13. An event notification system, comprising:
a. means for producing an ID number uniquely associated with an individual subscriber;
b. means for generating a list of persons to be notified upon the occurrence of an event;
c. means for providing the ID number at strategic public locations associated with the subscriber;
d. means for, upon the happening of an event, providing the ID number to a service provider; and
e. means for contacting at least one of the persons to be notified.

14. The system of claim 10, wherein said means for generating a list of persons further comprises means for providing information about persons to be notified into a web secure database.

15. The system of claim 10, wherein said means for providing the ID number at strategic public locations associated with the subscriber is a key ring tag.

16. The system of claim 10, wherein said means for providing the ID number at strategic public locations associated with the subscriber is an adhesive sticker.
